(19) United States
(12) Patent Application Publication
(10) Pub. No.: US 2015/0063132 A1
(43) Pub. Date: Mar. 5, 2015

(54) BANDWIDTH ESTIMATION MECHANISM FOR A COMMUNICATION NETWORK

(71) Applicant: QUALCOMM Incorporated, San Diego, CA (US)

(72) Inventors: Wayne Grosvenor Dunlap, Austin, TX (US); Benjamin Micael Menchaca, Austin, TX (US)

(73) Assignee: QUALCOMM Incorporated, San Diego, CA (US)

(21) Appl. No.: 14/016,923

(22) Filed: Sep. 3, 2013

(51) Int. Cl. H04L 12/26

(52) U.S. Cl. CPC H04L 43/0852
USPC 370/252

(57) ABSTRACT

A mechanism for determining the available bandwidth of a network is disclosed. The baseline latency of each of a plurality of routers on a network path between a first network device and second network device of a network is determined. A subsequent latency of each of the plurality of routers is determined. A bandwidth limiting router on the network path is identified based, at least in part, on the baseline latency and the subsequent latency of each of the plurality of routers. An available bandwidth associated with the network path is determined based, at least in part, on taking latency measurements of the bandwidth limiting router from the first network device.

### BACKGROUND

Embodiments of the inventive subject matter generally relate to the field of networks, and, more particularly, to dynamically estimating the available bandwidth of a network.

Local area networks (LANs), such as home or office networks, typically include a gateway (or router) that connects the LAN to a wide area network (WAN) and routes packets between the two networks. Various network devices in the LAN can access and download information from the Internet via the gateway. The gateway can manage the various uplink and downlink packet streams between the WAN and the LAN. The gateway can also provide various security features, such as a firewall, to prevent unauthorized or malicious attempts to remotely access the LAN.

### SUMMARY

Various embodiments are disclosed for implementing a bandwidth estimation technique in a communication network. In one embodiment, the baseline latency of each of a plurality of routers on a network path between a first network device and second network device of a network is determined. A subsequent latency of each of the plurality of routers is determined. A bandwidth limiting router on the network path is identified based, at least in part, on the baseline latency and the subsequent latency of each of the plurality of routers. An available bandwidth associated with the network path is determined based, at least in part, on the bandwidth limiting router.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram illustrating a bandwidth estimation mechanism for a communication network, according to some embodiments;

FIG. 2 is a flow diagram illustrating example operations for implementing the bandwidth estimation mechanism at a first network device of a communication network, according to some embodiments;

FIG. 3 is a block diagram of one embodiment of a network device including a mechanism for bandwidth estimation in a local area network, according to some embodiments.

FIG. 4 is a flow diagram illustrating example operations for implementing the bandwidth estimation mechanism at a first network device of a communication network, according to some embodiments;

FIG. 5 is a continuation of the flow diagram of FIG. 4 illustrating additional example operations for implementing the bandwidth estimation mechanism at the first network device of the communication network, according to some embodiments.

FIG. 6 is a network diagram showing example data packet transmissions from the first network device to routers in a network path between a first network device and a second network device to determine available bandwidth of the network path, according to some embodiments.

FIG. 7 is a block diagram of one embodiment of a network device including a mechanism for bandwidth estimation and control, according to some embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to implementing a bandwidth estimation technique at a gateway of a LAN, it is noted that the bandwidth estimation technique can be implemented by other suitable network devices in other networks. In other instances, well-known instruction instances, protocols, structures and techniques have not been shown in detail in order not to obfuscate the description.

Some existing network device can be configured to implement a bandwidth estimation technique to communicate with other network devices. One existing technique for determining the available bandwidth of a network is a network flooding-based mechanism. In this technique, the network device identifies the portion of the network on which to perform the bandwidth test. The network device begins to transmit data packets through this portion of the network. The quantity of data packets transmitted through the network is steadily increased to consume more network resources. For example, a first network device can upload a large data file, the size of which is known, to a second network device. The amount of time necessary to receive the entire file can be measured at the second network device. The quantity of data sent in bits and the time necessary to complete the upload to the second network device can be used to estimate the bandwidth of the network path between the first network device and the second network device. However, the network flooding-based technique does not provide an accurate estimate of the available bandwidth in the network path. Also, by implementing this network flooding-based technique, the consumption of the network resources can affect a user's ability to use the network and impact the overall network performance.

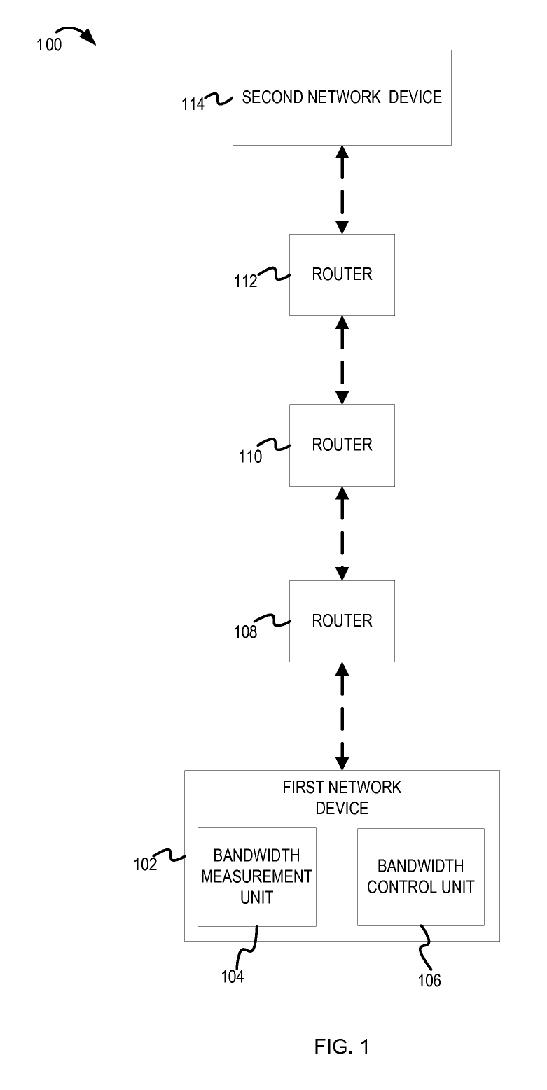

The present disclosure describes various techniques to accurately determine the available bandwidth of a network while minimizing or eliminating the impact on network performance. In some embodiments, a first network device can identify the routers in a network path between the first network device and a second network device. After identifying the routers in the network path, the first network device can determine baseline latency measurements for each router in the network path. The first network device can determine subsequent latency measurements for each router. The subsequent and baseline latency measurements can then be compared. The router in the network path that exhibits the largest magnitude difference in latency based on the subsequent and baseline latency measurements may be identified and designated the bandwidth limiting router of the network path. The first network device then can determine the available bandwidth of the network path based on additional measurements performed on the bandwidth limiting router, as will be further described below. The first network device can control the downstream and upstream data traffic that is transmitted via the network path based on the available bandwidth. Additional details of the various techniques for accurately determining the available bandwidth in a network path are discussed below with reference to FIGS. 1-7.

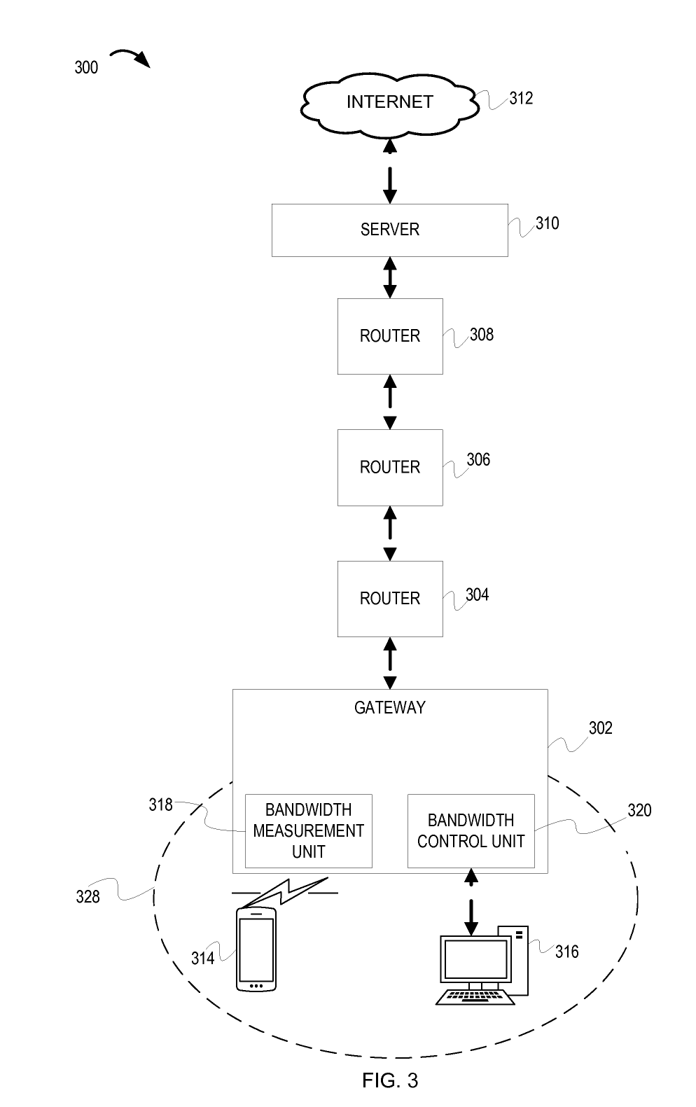

FIG. 1 is an example block diagram illustrating a bandwidth estimation mechanism for a communication network 100. As shown in FIG. 1, the communication network 100 includes a first network device 102, a second network device 114, and a plurality of routers 108, 110, and 112 coupled between the first network device 102 and the second network device 114. Although FIG. 1 shows three routers 108, 110, and 112 for simplicity, the communication network 100 could include any number of routers between the first network device 102 and the second network device 114 configured in any topology and not necessarily the example topology depicted in FIG. 1. The first network device 102 is capable of transmitting data to, and receiving data from, the second network device 114 via the network path of the communication network 100 that includes the plurality of routers 108, 110, and 112. In some implementations, the first network device 102 can be a gateway (or router) of a LAN that is part of the communication network 100 (as will be further described below in FIG. 3). The communication network 100 may be a WAN, which may be part of the Internet. The second network device 114 can be a server of a service provider; for example, the second network device 114 may be a server of an Internet Service Provider (ISP). In some embodiments, the first network device 102 can implement a bandwidth estimation technique to determine the available bandwidth in the network path between the first network device 102 and the second network device 114, as will be further described below. The first network device 102 can also control a bandwidth allocated for downstream and upstream data traffic at the first network device 102 based on the available bandwidth in the network path.

In some embodiments, the first network device 102 can include a bandwidth measurement unit 104 and a bandwidth control unit 106. The bandwidth measurement unit 104 can implement the bandwidth estimation technique in the communication network 100 to determine the available bandwidth associated with the network path between the first network device 102 and the second network device 114. In one implementation, the bandwidth measurement unit 104 can perform latency measurements for each of the routers of the network path between the first network device 102 and the second network device 114. The bandwidth measurement unit 104 can identify the bandwidth limiting router from the plurality of routers 108, 110, and 112 based on the latency measurements. The bandwidth limiting router may be the router in the network path between the first network device 102 and the second network device 114 that limits the amount of downstream and upstream data traffic that can be transmitted via the network path. After identifying the bandwidth limiting router, the bandwidth measurement unit 104 can then determine the available bandwidth of the network path, as will be further described below. Thus, for example, if router 110 is determined to be the bandwidth limiting router, then the available bandwidth of the network path between the first network device 102 and the second network device 114 should not be higher than the bandwidth that can be supported by the router 110, otherwise the network path may experience data loss (e.g., dropped packets). After determining the available bandwidth of the network path, the bandwidth control unit 106 can configure the first network device 102 to limit the bandwidth allocated to downstream and upstream traffic along the network path based on the available bandwidth, as will be further described below.

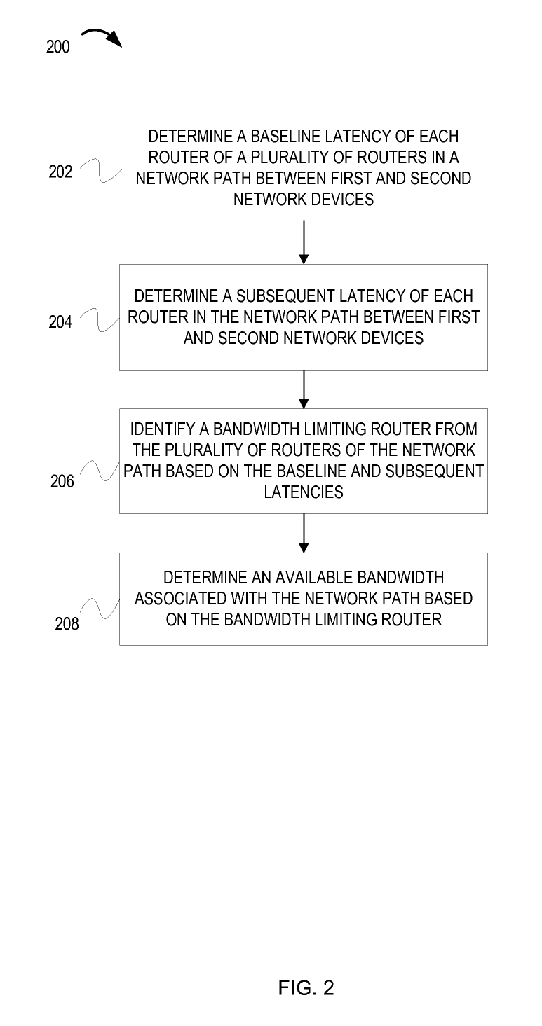

FIG. 2 is a flow diagram (“flow”) 200 illustrating example operations for implementing the bandwidth estimation mechanism at a first network device of a communication network, according to some embodiments. The flow begins at block 202 and concludes at block 208.

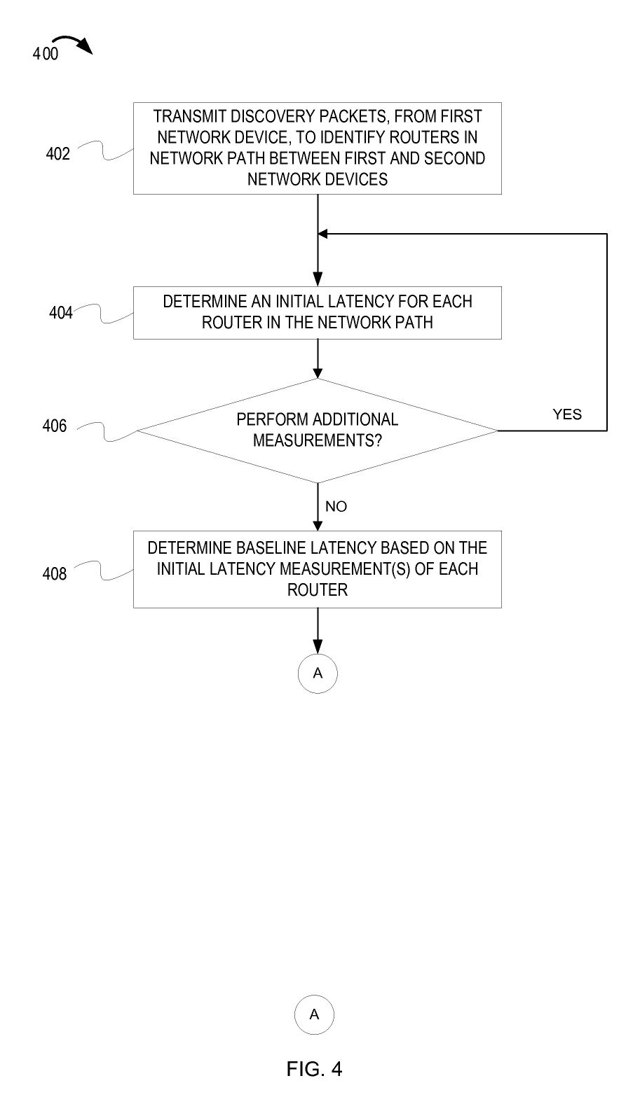

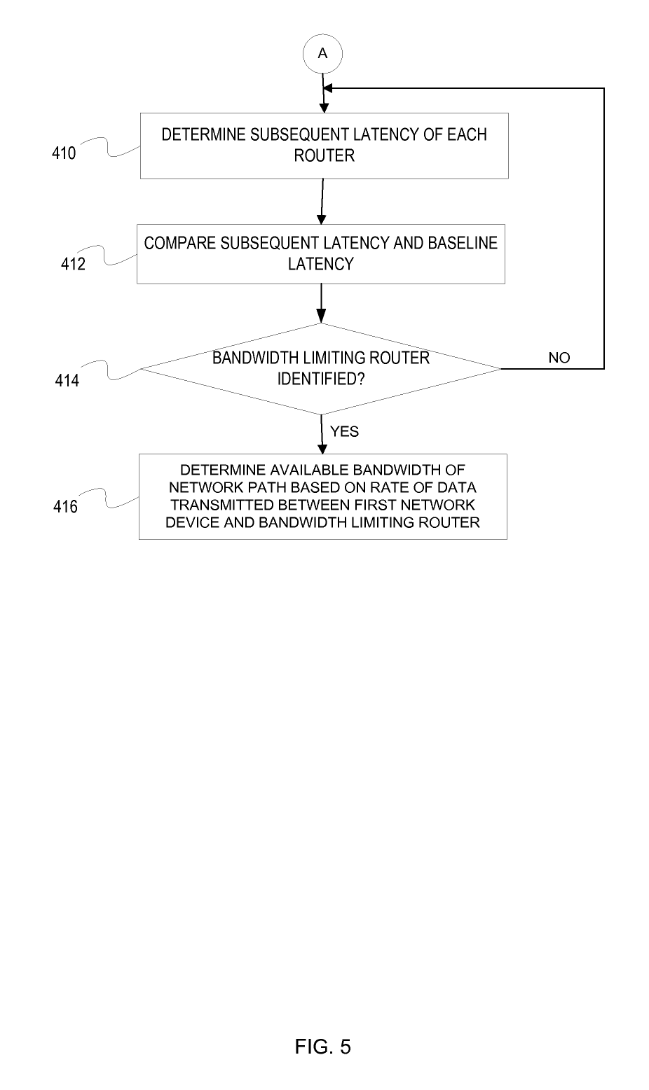

At block 202, a baseline latency of each router between the first network device and the second network device is determined. In some embodiments, the bandwidth measurement unit 104 of the first network device 102 can determine the baseline latency (also referred to as “baseline latency measurement”) of each router 108, 110, and 112 in the network path between the first network device 102 and the second network device 114. In one implementation, the bandwidth measurement unit 104 can transmit a discovery packet to each router 108, 110, and 112. The bandwidth measurement unit 104 determines the baseline latency for each router 108, 110 and 112 by measuring the time elapsed between sending the discovery packet and receiving a response packet (e.g., as will be further described below with reference to FIGS. 4-5).

At block 204, a subsequent latency of each router is determined. In some embodiments, the bandwidth measurement unit 104 can determine the subsequent latency (also referred to as “subsequent latency measurement”) of each router 108, 110, and 112 in the network path between the first network device 102 and the second network device 114. Similar to the baseline latency, in one implementation, the bandwidth measurement unit 104 can transmit a discovery packet to each router 108, 110, and 112 and determine the subsequent latency for each router 108, 110 and 112 by measuring the time elapsed between sending the discovery packet and receiving a response packet (e.g., as will be further described below with reference to FIGS. 4-5).

At block 206, a bandwidth limiting router is identified from the plurality of routers of the network path based, at least in part, on the baseline latency and subsequent latency of each router. The bandwidth measurement unit 104 may identify the bandwidth limiting router from among the plurality of routers in the network path based, at least in part, on the baseline latency and subsequent latency of each router. For example, the bandwidth measurement unit 104 can compare the baseline latency and subsequent latency of each router to identify the router on the network path that exhibits a significant increase in latency, as will be further described below. This router can be designated the bandwidth limiting router. In one implementation, the bandwidth measurement unit 104 can determine the magnitude difference between the subsequent latency and baseline latency of each router on the network path. The bandwidth measurement unit 104 can then compare the magnitude differences of each router, identifying the router that exhibits a significant magnitude difference between subsequent latency and baseline latency. This router can be the bandwidth limiting router. Whether the magnitude difference between the subsequent latency and baseline latency of each router is a significant magnitude difference can be assessed using various techniques, as will be further described below in FIGS. 4, 5, and 6. In one example, the bandwidth measurement unit 104 can compare the magnitude difference of each router to a latency difference threshold and identify the router with the largest magnitude difference that exceeds the magnitude difference threshold (as described below in FIG. 4).

At block 208, an available bandwidth associated with the network path between the first network device 102 and the second network device 114 is determined based on the bandwidth limiting router. As discussed more fully below, the bandwidth measurement unit 104 can measure the latency of the bandwidth limiting router, and this latency can be used to estimate the available bandwidth of the network path.

Although FIG. 2 describes example operations for implementing the bandwidth estimation mechanism, additional example operations that can be performed in conjunction with (or instead of) the operations of FIG. 2 will be described in detail below with reference to FIGS. 3-6.

FIG. 3 is a block diagram of one embodiment of a network device including a mechanism for bandwidth estimation in a local area network, according to some embodiments. As shown in FIG. 3, the first network device 102 of FIG. 1 can be a gateway 302 supporting a LAN 328. The second network device 114 of FIG. 1 can be an ISP's server 310 that provides the LAN 328 access to the Internet 312 and other web-based services. The gateway 302 may be a network traffic managing node between two or more networks that receives, processes, and routes downstream and upstream data packets associated with the networks. The gateway 302 may be a dedicated gateway or may be a computer or server or other network device of the LAN 328 that implements the functionality of a gateway for the LAN 328, which may also be referred to herein as a gateway. As shown in FIG. 3, the gateway 302 may allow the network devices 314 and 316 of the LAN 328 to access the Internet 312 and receive content from the Internet 312 via the ISP's server 310. In one example, the network device 314 may be a smartphone and the network device 316 may be a desktop computer. It is noted, however, that the network devices of the LAN 328 may include various type of wired and wireless networking devices, such as notebook computers, tablet computers, digital cameras, televisions, gaming consoles, smart appliances, and other suitable network devices. A plurality of routers 304, 306, and 308 may be located in the network path between the gateway 302 and the server 310. The routers 304-308 may be dedicated routers, or may be other suitable network devices that are capable of implementing a routing function and may also be referred to herein as routers. For example, one or more of the routers 304, 306, 308 can be a computer or server that implements a routing function along the network path. Similarly as described above in FIGS. 1-2 for the first network device 102, the gateway 302 can include a bandwidth measurement unit 318 and a bandwidth control unit 320 to implement the bandwidth estimation and control techniques, which will be further described below with reference to FIGS. 4-6.

FIG. 4 is a flow diagram illustrating example operations for implementing the bandwidth estimation mechanism at a first network device of a communication network, according to some embodiments. The flow begins at block 402 and continues to block 418 of FIG. 5.

At block 402, one or more discovery packets are transmitted from the first network device to discover the existence and address of each router in a network path between the first network device and the second network device. For example, in the context of FIG. 3, the bandwidth measurement unit 318 of the gateway 302 can use an internet protocol (IP) data packet as a discovery packet. Each IP packet has an eight bit time-to-live (TTL) field. A TTL value ranging from 0 to 255 can be selected. This value is an upper-bound limit of the amount of time that an IP packet can exist on the Internet. Each router that the discovery packet encounters on its way to its final destination decrements the TTL value by one. If the TTL field equals zero before the discovery packet reaches its destination (e.g., the server 310), then the discovery packet is discarded and an Internet control message protocol (ICMP) time exceeded error message is returned to the gateway 302 together with the address of the router or device that generated the ICMP time exceeded error message.

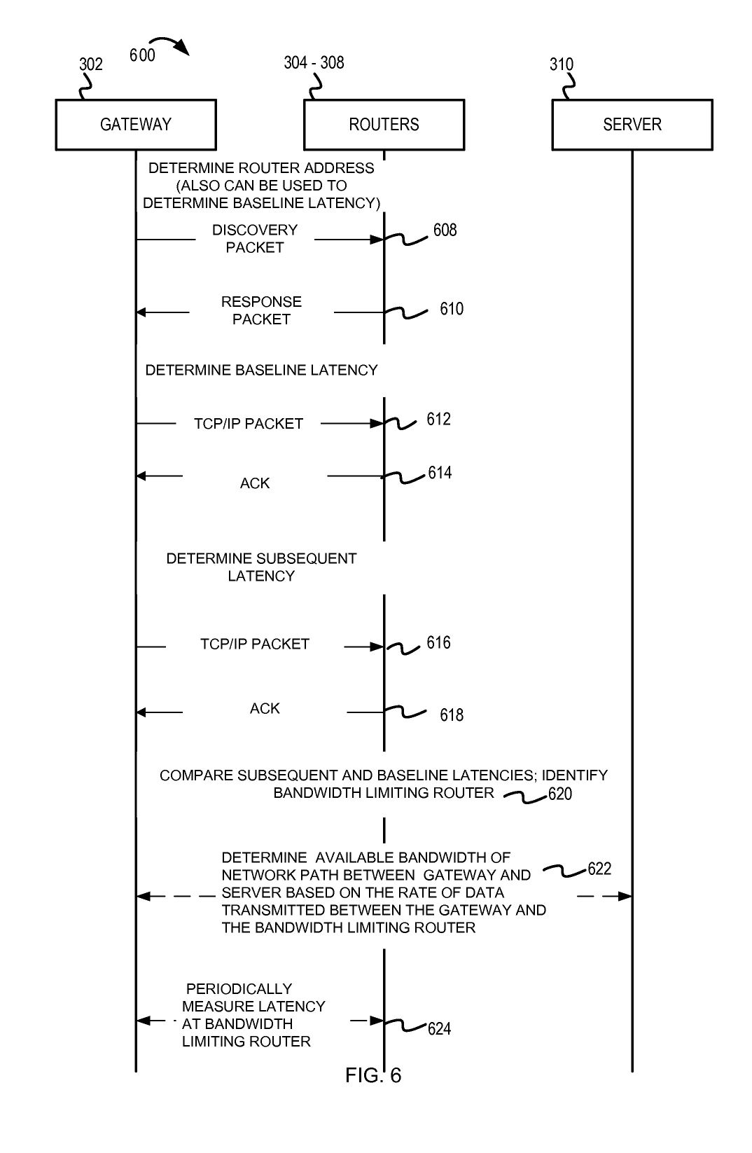

In one implementation, the gateway 302 can transmit a discovery packet that includes a TTL value of 1. In response to transmitting the discovery packet, the gateway 302 receives an internet control message protocol (ICMP) time exceeded error message and an address from the router 304 (i.e., the first router the discovery packet encountered). The gateway transmits another discovery packet that includes a TTL value of 2. The gateway receives an ICMP time exceeded error message and an address from the router 306. This process continues iteratively until the gateway 302 has received the address of each router 304, 306, 308 between the gateway 302 and the server 310. FIG. 6 also depicts this process. FIG. 6 is a network diagram 600 showing an example of various packets being transmitted from the gateway 302 to routers 304, 306, and 308 in the network path between the gateway 302 and the server 310. For example, FIG. 6 depicts the transmission of a discovery packet 608 and receipt of a response packet 610 to detect each router 304, 306, and 308 in the network path and determine each router's address. It is noted, however, that in other embodiments the address of each router 304, 306, and 308 between the gateway 302 and the server 310 can be determined using other network topology discovery techniques known in the art.

At block 404, an initial latency is determined for each router 304, 306, and 308 in the network path between the first network device and the second network device. In one embodiment, the bandwidth measurement unit 318 transmits a data packet. The bandwidth measurement unit 318 records the time at which it transmits this data packet. The bandwidth measurement unit 318 receives an acknowledgment (ACK) message from the router 304 in response to this transmitted data packet. The bandwidth measurement unit 318 records the time at which it receives the ACK message. The difference between these two times is the round trip time (RTT), which can be used as a measure of the initial latency of the router 304. This procedure can be repeated for each router 306 and 308 between the gateway 302 and the server 310. In some embodiments, the data packet used to determine the latency of each router 304, 306, and 308 can be the discovery packet transmitted to determine the address of each router 304, 306, and 308. As shown in FIG. 6, a discovery packet 608 may be sent from the gateway 302 to each router 304, 306, and 308. The gateway 302 receives a response packet 610 from each router 304, 306, and 308. By measuring the time elapsed between transmitting the discovery packet 608 and receiving the response packet 610, the bandwidth measurement unit 318 can determine the latency of each router 304, 306, and 308. As described above, the response packet 610 also includes the address of the corresponding router. As shown in FIG. 6, in another implementation, after each router's address is determined, the bandwidth measurement unit 318 can transmit to each router 304, 306, and 308 a TCP/IP data packet 612, receive a corresponding ACK message 614, and measure the RTT associated with the transmission of the TCP/IP data packet 612 and the reception of the ACK message 614, which constitutes a measure of the latency of each router 304, 306, and 308.

At block 406, a determination is made as to whether to perform additional latency measurements. The bandwidth measurement unit 318 can be configured to perform one latency measurement or several. In one embodiment, the bandwidth measurement unit 318 is configured to take a single latency measurement for each router 304, 306, and 308. In another embodiment, the bandwidth measurement unit 318 is configured to take a plurality of latency measurements. In one example, the bandwidth measurement unit 318 can be configured such that, by default, it performs a single latency measurement for each router 304, 306, and 308. However, the bandwidth measurement unit 318 can be configurable to perform additional latency measurements. For example, a user of the gateway 302 can change the configuration of the gateway 302 from the default configuration of performing one latency measurement to the configuration of performing multiple latency measurements. Alternatively, the bandwidth measurement unit 318 can, by default, be configured to perform multiple latency measurements. In one example, when the gateway 302 is configured to perform multiple latency measurements, the quantity of measurements taken can be a predefined number of measurements (e.g., a statistically sufficient sample determined through experimentation), and/or can be a configurable number of measurements. If the bandwidth measurement unit 318 is configured to take a single latency measurement, the flow proceeds to block 408. Conversely, if the bandwidth measurement unit 318 is configured to take multiple latency measurements, the flow again returns to block 404 until the configured quantity of latency measurements are taken.

At block 408, the baseline latency of each router 304, 306, 308 is determined based upon one or more initial latency measurements of each router. For example, if the bandwidth measurement unit 318 obtained a single latency measurement of each router 304, 306, and 308, then each measurement constitutes the baseline latency measurement of each corresponding router. However, if multiple initial latency measurements were obtained for each router 304, 306, and 308, then the baseline latency is determined based on at least one of the initial latency measurements. In one implementation, when multiple initial latency measurements are collected for each router 304, 306, and 308, the minimum latency measurement of each router can be selected as the baseline latency measurement of each router 304, 306, and 308. It is noted, however, that in other implementations, when multiple latency measurements are collected, the bandwidth measurement unit 318 can take the average of the latency measurements, and the average for each router 304, 306, and 308 is the baseline latency of such router 304, 306, and 308. Additionally, the bandwidth measurement unit 318 can perform other statistical analyses of the multiple measurements such as, for example, finding the variance and standard deviation of these measurements for each router 304, 306, and 308. FIG. 6 depicts one example of this determination of the baseline latency of each router by transmitting one or more TCP/IP data packets 612 from the gateway 302 to each router 304, 306, and 308, and measuring the time necessary to receive an ACK 614 at the gateway 302 from each router 304, 306, and 308 to determine the baseline latencies of each router. The flow then proceeds to blocks 410, 412, and 414 of FIG. 5. Blocks 410, 412, and 414 are implemented to identify a bandwidth limiting router, which is the router among the routers 304, 306, or 308 that exhibits the most significant increase in latency between the baseline latency and subsequent latency. At block 410, the bandwidth measurement unit 318 may determine the subsequent latency of each router 304, 306, and 308. The procedure used to determine a subsequent latency for each router 304, 306, and 308 can be similar to the procedure used to detect the baseline latency of each router 304, 306, and 308. For example, the gateway 302 can send a discovery packet from the bandwidth measurement unit 318 to each router 304, 306, and 308. The bandwidth measurement unit 318 can record the time at which it transmits this discovery packet. When the bandwidth measurement unit 318 receives an ACK or response packet from a router, it can measure the time at which it receives the ACK or response packet. The difference in time then constitutes the subsequent latency of each router 304, 306, and 308. In one embodiment, the bandwidth measurement unit 318 may take a single subsequent latency measurement of each router 304, 306, and 308, and the flow proceeds to blocks 412 and 414. However, in another implementation, the bandwidth measurement unit 318 may take multiple subsequent latency measurements of each router 304, 306, and 308; for example, the bandwidth measurement unit 318 may take a predefined number (e.g., a statistically significant number) of latency measurements for each router 304, 306, and 308. In some examples, the number of latency measurements that are taken can be configurable. The bandwidth measurement unit 318 can select the minimum latency measurement for each router 304, 306, and 308. This minimum can constitute the subsequent latency measurement for each router 304, 306, and 308. Alternatively, the bandwidth measurement unit 318 can determine the mean of the latency measurements taken for each router 304, 306, and 308. The mean then can constitute the subsequent latency measurement for each router 304, 306, and 308. The flow then proceeds to blocks 412 and 414. As will be further described below in blocks 412 and 414, the bandwidth measurement unit 318 can compare the subsequent latency and the baseline latency of each router to determine the bandwidth limiting router. However, if the bandwidth limiting router is not identified based on this set of measurements, the bandwidth measurement unit 318 can take another set of subsequent latency measurements. FIG. 6 illustrates one example of this determination of the subsequent latency for each router. As with the determination of baseline latency, a bandwidth measurement unit 318 can transmit a single TCP/IP data packet 616 or multiple TCP/IP data packets 616 to each router 304, 306, and 308. The bandwidth measurement unit 318 then can measure the amount of time elapsed until it receives an ACK message 618 from each router. The elapsed time constitutes a latency measurement of each router 304, 306, and 308.

At block 412, the bandwidth measurement unit 318 can compare the baseline latency measurement and the subsequent latency measurement for each router 304, 306, and 308 to identify the router that exhibits the most significant increase between its subsequent latency and baseline latency. In some implementations, the bandwidth measurement unit 318 can determine the magnitude difference between the subsequent latency and baseline latency for each router 304, 306, and 308. For example, the bandwidth measurement unit 318 can compare the magnitude difference of each router 304, 306, and 308 to a magnitude difference threshold. As will be described below, the bandwidth measurement unit 318 can identify the router with the largest magnitude difference that exceeds the latency difference threshold, and designate that router the bandwidth limiting router. The latency difference threshold can be determined by various techniques, as will be further described below. If no router 304, 306, or 308 exhibits a magnitude difference between the subsequent latency and baseline latency that exceeds the latency difference threshold, then the flow returns to block 410. The bandwidth measurement unit 318 then can take another subsequent latency measurement at each router 304, 306, and 308. If the magnitude difference between subsequent latency and baseline latency for a router 304, 306, or 308 exceeds the latency difference threshold, then the router with the largest magnitude difference that also exceeds the latency difference threshold is designated as the bandwidth limiting router. Otherwise, the flow again returns to block 410, repeating iteratively through block 414, until the bandwidth measurement unit 318 identifies a bandwidth limiting router. FIG. 6 also illustrates the comparison between the baseline latency measurement and subsequent latency measurement of each router to identify the bandwidth limiting router, as noted by the comparison operation 620.

The latency difference threshold can be determined in different ways in particular embodiments. In one implementation, the latency difference threshold is a multiple of the standard deviation of the magnitude difference between the subsequent latency and baseline latency of each router 304, 306, and 308. For example, the bandwidth measurement unit 318 can determine the mean and variance of the magnitude difference in the subsequent latency and baseline latency for each router 304, 306, and 308. The bandwidth measurement unit 318 can determine the standard deviation of the magnitude difference in the subsequent and baseline latencies from the mean and variance calculations. The bandwidth measurement unit 318 may select a multiple of this standard deviation as the latency difference threshold; for example, the bandwidth measurement unit 318 can select twice the standard deviation as the latency difference threshold. As discussed above, if the magnitude difference between the subsequent latency measurement and baseline latency measurement of a router 304, 306, or 308 exceeds this latency difference threshold, then the router 304, 306, or 308 is designated as the bandwidth limiting router. In another embodiment, the latency difference threshold can be empirically determined based, at least in part, on data collected through applying the standard deviation technique as described above to identify the bandwidth limiting router. For instance, multiple trials can be performed using the technique described above. Data from these trials can be analyzed, and a representative latency difference threshold can be determined based upon this data. The latency difference threshold can be used to identify the bandwidth limiting router.

In another implementation, although not shown in FIG. 4, after determining the baseline latencies of each router, the flow can proceed to block 410 after detecting a dropped data packet in the network path. In one implementation, the rate at which data packets are transmitted between the gateway 302 and the server 310 increased and the network path between the gateway 302 and the server 310 is monitored. The bandwidth measurement unit 318 can be configured to periodically increase the data transmission rate by a fixed percentage per unit of time. Alternatively, the bandwidth measurement unit 318 can be configured to variably increase the data transmission rate. After each increase, the bandwidth measurement unit 318 can monitor the network path to determine if there is at least one dropped data packet. If the bandwidth measurement unit 318 has not detected at least one dropped data packet, then it continues to increase the rate of data transmission until it detects such a dropped data packet. In another embodiment, without actively increasing the data rate, the bandwidth measurement unit 318 can monitor data sent and received between the gateway 302 and the server 310 to determine whether at least one data packet is dropped. In one example, a dropped data packet can be detected by transmitting a discovery packet and receiving a retransmission timeout. Alternatively, a dropped data packet can be detected by transmitting a discovery packet and then receiving a certain number of duplicate ACKs (e.g., ACKs with the same sequence number). For example, the bandwidth measurement unit 318 can be configured such that receipt of at least two duplicate ACKs after transmission of a discovery packet is defined to indicate a data packet was dropped in the network path. In these implementations, in response to detecting one or more dropped packets, the bandwidth measurement unit 318 can determine the subsequent latency of each router, similarly as was described above.

At block 416, the bandwidth measurement unit 318 can determine the available bandwidth of the network path between a gateway 302 and a server 310 based on the rate of data transmitted between the gateway 302 and the bandwidth limiting router. In one implementation, the bandwidth measurement unit 318 can determine the available bandwidth of the network path when it identifies the bandwidth limiting router. The available bandwidth of the network path can be the rate at which the bandwidth measurement unit 318 transmitted data to the routers 304, 306, and 308 when it identified the bandwidth limiting router. For example, the bandwidth measurement unit 318 can determine the rate at which data was transmitted in the network path when it identified the router with the largest magnitude difference that exceeded the latency difference threshold. FIG. 6 also depicts determining the available bandwidth of the network based upon the data rate of packets that were transmitted from the first network device to the bandwidth limiting router to identify the bandwidth limiting router, as noted by the available bandwidth operation 622.

In another embodiment, after identifying the bandwidth limiting router, the available bandwidth can be determined by decreasing the transmission rate of data sent between the gateway 302 and the server 310 until the latency of the bandwidth limiting router approximately equals its baseline latency. In some embodiments, the data transmission rate may be decreased by a fixed percentage. After the rate is decreased by such a percentage, the bandwidth measurement unit 318 can measure the latency of the bandwidth limiting router. If the latency of the bandwidth limiting router is approximately equal to its baseline latency, then the bandwidth measurement unit 318 measures the rate of data transmission sent to the bandwidth limiting router. This rate of data transmission approximates the available bandwidth of the network path between the gateway 302 and the server 310. Otherwise, the transmission rate again is reduced and the bandwidth measurement unit 318 again measures the latency of the bandwidth limiting router, proceeding iteratively until the latency of the bandwidth limiting router approximately equals its baseline latency. In another implementation, the data transmission rate between the gateway 302 and the server 310 is reduced by a variable amount, but, after each reduction, the bandwidth measurement unit 318 measures the latency of the bandwidth limiting router. If the latency of the bandwidth limiting router approximately equals its baseline latency, then the bandwidth measurement unit 318 measures the rate of data transmission to the bandwidth limiting router, and this rate approximates the available bandwidth of the network path between the gateway 302 and the server 310. Otherwise, the data transmission rate along the network path is reduced until the latency of the bandwidth limiting router approximately equals its baseline latency.

In another implementation, rather than reducing the transmission rate of data packets sent between the gateway 302 and the server 310 until the latency of the bandwidth limiting router approximately returns to its baseline latency, the transmission rate of data packets sent between the gateway 302 and the server 310 is reduced until the gateway 302 does not detect any dropped data packets. For example, the bandwidth measurement unit 318 can reduce the data transmission rate by a fixed amount. After such a transmission rate reduction, the bandwidth measurement unit 318 can monitor the network path to detect any dropped data packets. If any dropped data packets are detected, the bandwidth measurement unit 318 can again reduce the transmission rate, and continue monitoring the network path. This process proceeds iteratively until no dropped data packets are detected by the bandwidth measurement unit 318.

The bandwidth measurement unit 318 then determines the available bandwidth of the network path between the gateway 302 and the server 310. In one implementation, the bandwidth measurement unit 318 can determine the available bandwidth of the network path based on the data rate when the latency of the bandwidth limiting router approximately equals its baseline latency. In another implementation, the bandwidth measurement unit 318 can determine the available bandwidth based on the data rate when the bandwidth measurement unit 318 does not detect any dropped data packets in the network path.

Furthermore, in some implementations, the bandwidth measurement unit 318 can periodically measure the latency of the bandwidth limiting router. For example, if the latency of the bandwidth limiting router as measured at the bandwidth measurement unit 318 is high, then it can determined that the rate of data traffic passing through the bandwidth limiting router is too high for the capacity of the router. Conversely, if the latency of the bandwidth limiting router as measured at the bandwidth measurement unit 318 is low, then it can be determined that the rate of data traffic passing through the bandwidth limiting router is sufficient for the capacity of the router. Thus, latency measurements taken at the bandwidth limiting router can be used to estimate the bandwidth of the network path between the gateway 302 and the server 310. Moreover, periodic latency measurements of the bandwidth limiting router taken at the gateway 302 can be used as an estimate of the bandwidth of the network path between the gateway 302 and the server 310 as a function of time. FIG. 6 shows this approach of periodically measuring the latency of the bandwidth limiting router to estimate the available bandwidth of the network path, as noted by the periodic measurement operation 624.

In one implementation, the bandwidth measurement unit 318 is coupled to a bandwidth control unit 320. The bandwidth measurement unit 318 can measure the latency of the bandwidth limiting router, and provide these latency measurements to the bandwidth control unit 320. If the latency of the bandwidth limiting router increases based on measurements that the bandwidth measurement unit 318 collects, the bandwidth control unit 320 can reduce the data traffic flow between the gateway 302 and the server 310. If the latency of the bandwidth limiting router decreases, the bandwidth control unit 320 can permit a higher data transmission rate of traffic between the gateway 302 and the server 310. In one embodiment, the bandwidth measurement unit 318 can measure the latency of the bandwidth limiting router as described above. The bandwidth measurement unit 318 can then transmit this latency measurement to the bandwidth control unit 320. This process can be repeated iteratively so that the bandwidth control unit 320 accumulates data about the latency of the bandwidth limiting router. The bandwidth control unit 320 can monitor this data, searching for instances of latencies that are high relative to other recorded latencies of the bandwidth limiting router. Thus, if the latency of the bandwidth limiting router begins to increase relative to other recorded latencies, the bandwidth control unit 320 can cause the gateway 302 to reduce the rate of data transmission on the network path.

It should be understood that FIGS. 1-7 are examples meant to aid in understanding embodiments and should not be used to limit embodiments or limit scope of the claims. Embodiments may comprise additional circuit components, different circuit components, and/or may perform additional operations, fewer operations, operations in a different order, operations in parallel, and some operations differently. For example, the discovery packet 608, 612 and response packet 610, 614 to which FIG. 6 refers could be any data packet that causes a receiving device to generate a response.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

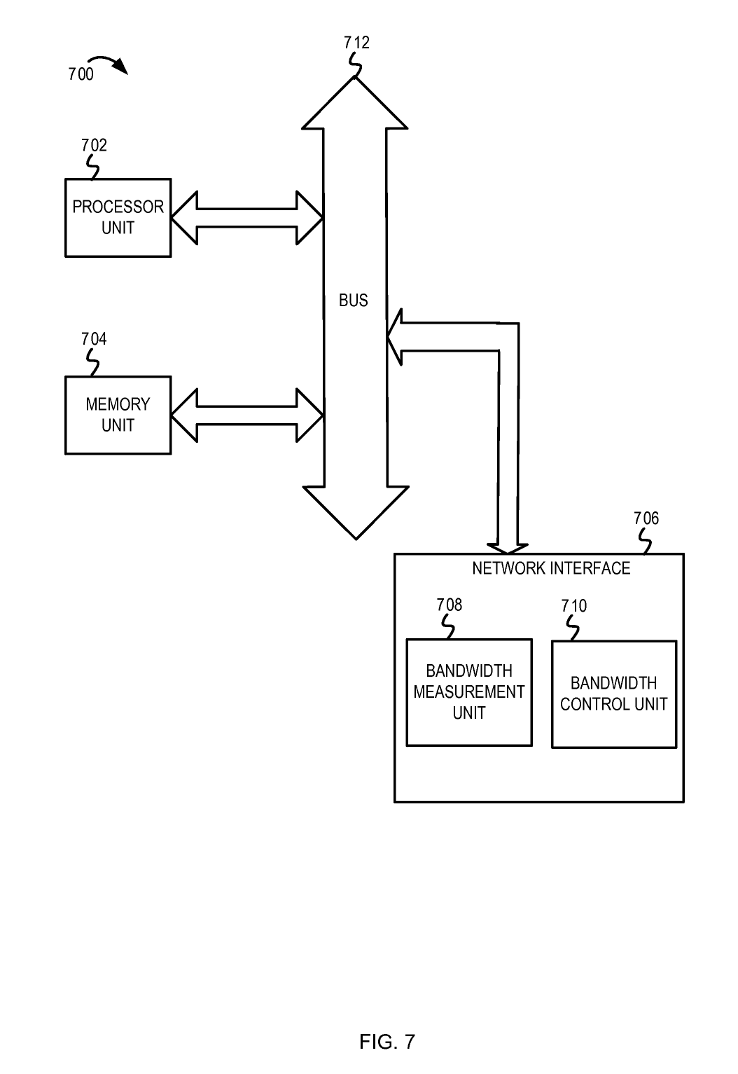

FIG. 7 is a block diagram of one embodiment of a network device 700 including a bandwidth measurement unit 708, according to some embodiments. In some implementations, the network device 700 is a network traffic managing node between two or more networks (e.g., a LAN and a WAN) that receives, processes, and routes packets associated with the networks; for example, the network traffic managing node may be a router/gateway of a LAN (e.g., LAN 328 shown in FIG. 3). It is noted, however, that in other implementations the network device 700 may be other suitable types of network devices that can be configured to implement the functionality described above with reference to FIGS. 1-6, such as a cable modem, a wireless access point, a network bridge, a network switch, a desktop computer, a mobile computing device, etc. The network device 700 includes a processor unit 702 (possibly including multiple processors, multiple cores, multiple nodes, and/or implementing multi-threading, etc.). The network device 700 includes a memory unit 704. The memory unit 704 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media. The network device 700 also includes a bus 712 (e.g., PCI, ISA, PCI-Express, HyperTransport®, InfiniBand®, NuBus, AHB, AXI, etc.), and network interface(s) 706 that include at least one of a wireless network interface (e.g., a Bluetooth interface, a WLAN 802.11 interface, a WiMAX interface, a ZigBee® interface, a Wireless USB interface, etc.) and a wired network interface (e.g., an Ethernet interface, a powerline communication interface, etc.).

As illustrated, the network interface(s) 706 also includes a bandwidth measurement unit 708 and a bandwidth control unit 710. The bandwidth measurement unit 708 and the bandwidth control unit 710 execute the functionality described above with reference to FIGS. 1-6. This functionality can be implemented in software, firmware, and/or hardware. For example, the bandwidth measurement unit 708 and/or the bandwidth control unit 710 can be implemented with one or more application specific integrated circuits, one or more system-on-a-chip (SoC), or other hardware/software/firmware instantiations. Further, realizations may include fewer or additional components not illustrated in FIG. 7 (e.g., video cards, audio cards, additional network interfaces, peripheral devices, etc.). The processor unit 702, the memory unit 704, and the network interfaces 706 are coupled to the bus 712. Although illustrated as being coupled to the bus 712, the memory unit 704 may be coupled to the processor unit 702.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining, at a first network device, a baseline latency of each of a plurality of routers on a network path between the first network device and a second network device of a network;
determining a subsequent latency of each of the plurality of routers in the network path;
identifying, from the plurality of routers, a bandwidth limiting router on the network path based, at least in part, on the baseline latency and the subsequent latency of each of the plurality of routers; and
determining an available bandwidth associated with the network path based, at least in part, on the bandwidth limiting router.

2. The method of claim 1, wherein said identifying the bandwidth limiting router on the network path comprises:
determining a magnitude difference between the subsequent latency and the baseline latency of each of the plurality of routers; and
comparing the magnitude differences of the plurality of routers to identify the bandwidth limiting router.

3. The method of claim 2, wherein said comparing the magnitude differences of the plurality of routers to identify the bandwidth limiting router comprises:
determining that a magnitude difference between the subsequent latency and the baseline latency of a first router from the plurality of routers exceeds a latency difference threshold; and
designating the first router as the bandwidth limiting router of the network path.

4. The method of claim 2, wherein said comparing the magnitude differences of the plurality of routers to identify the bandwidth limiting router comprises:
determining that a magnitude difference between the subsequent latency and the baseline latency of a first router from the plurality of routers exceeds a latency difference threshold;
determining that the magnitude difference between the subsequent latency and the baseline latency of the first router is the largest magnitude difference associated with the plurality of routers; and
designating the first router as the bandwidth limiting router of the network path.

5. The method of claim 1, wherein said determining the available bandwidth associated with the network path comprises:
determining a data rate used for transmitting data packets in the network path when the bandwidth limiting router is identified; and
determining the available bandwidth associated with the network path based, at least in part, on the data rate.

6. The method of claim 1, further comprising determining the available bandwidth associated with the network path based, at least in part, on latency measurements associated with the bandwidth limiting router.

7. The method of claim 1, further comprising:
identifying the plurality of routers between the first network device and the second network device; and
determining an address of each of the plurality of routers.

8. The method of claim 1, further comprising:
in response to determining the baseline latency of each router on the network path, monitoring downstream and upstream data packets transmitted between the first network device and the second network device to detect a dropped packet in the network path; and
in response to detecting the dropped packet, determining the subsequent latency of each of the plurality of routers.

9. The method of claim 8, further comprising:
in response to determining the baseline latency of each router on the network path, increasing a data rate of transmitting data packets between the first network device and the second network device until detecting the dropped packet.

10. The method of claim 1, wherein said determining the baseline latency of each of the plurality of routers comprises:
transmitting a discovery packet from the first network device to each router to cause each router to transmit a response packet to the first network device; and
determining the baseline latency of each router based, at least in part, on the response packet received at the first network device from each router.

11. The method of claim 1, wherein said determining the baseline latency of each of the plurality of routers comprises, for each of the plurality of routers:
transmitting a plurality of discovery packets from the first network device to the router to cause the router to transmit a response packet for each discovery packet transmitted to the router;
determining initial latency measurements for the router based, at least in part, on the response packets received at the first network device from the router; and
determining the baseline latency of the router based, at least in part, on the initial latency measurements.

12. The method of claim 11, wherein said determining the baseline latency of the router based, at least in part, on the initial latency measurements comprises selecting, from the initial latency measurements for each router, a minimum latency measurement as the baseline latency for each router.

13. The method of claim 1, wherein said determining the available bandwidth associated with the network path comprises:
reducing a data rate of transmitting discovery packets from the first network device to the second network device after said identifying the bandwidth limiting router;
determining a reduced data rate of transmitting discovery packets when no data packets are dropped by the bandwidth limiting router; and
determining the available bandwidth associated with the network path based, at least in part, on the reduced data rate.

14. The method of claim 1, wherein said determining the available bandwidth associated with the network path comprises:
reducing a data rate of transmitting discovery packets from the first network device to the second network device in response to said identifying the bandwidth limiting router;
determining a reduced data rate of transmitting discovery packets when a latency associated with a bandwidth limiting router is approximately equal to the baseline latency of the bandwidth limiting router; and
determining the available bandwidth associated with the network path based, at least in part, on the reduced data rate.

15. The method of claim 1, wherein said determining the subsequent latency of each of the plurality of routers comprises:
transmitting a discovery packet from the first network device to each router to cause each router to transmit a response packet to the first network device; and
determining the subsequent latency of each router based, at least in part, on the response packet received at the first network device from each router.

16. The method of claim 1, wherein said determining the subsequent latency comprises:
for each of the plurality of routers,
transmitting a plurality of data packets from the first network device to the router to cause the router to transmit a response packet for each packet transmitted to the router;
determining additional latency measurements for the router based, at least in part, on the response packets received at the first network device from the router; and
determining the subsequent latency of the router based, at least in part, on the additional latency measurements.

17. The method of claim 16, wherein said determining the subsequent latency of the router based, at least in part, on the additional latency measurements comprises selecting, from the additional latency measurements, a minimum latency measurement as the subsequent latency.

18. The method of claim 1, wherein said identifying the bandwidth limiting router of the network path comprises:
determining a difference between the subsequent latency and the baseline latency for each of the plurality of routers;
determining a standard deviation associated with difference measurements between the subsequent latency and the baseline latency for each of the plurality of routers;
comparing the subsequent latency of each router to the standard deviation; and
identifying, from the plurality of routers, a first router in which the subsequent latency deviates most from the standard deviation with respect to the baseline latency; and
designating the first router as the bandwidth limiting router.

19. The method of claim 1 further comprising:
dynamically determining the available bandwidth of the first network device by periodically transmitting, from the first network device, a discovery packet to cause the bandwidth limiting router to transmit a response packet to the first network device and monitoring changes in a latency associated with the bandwidth limiting router.

20. A first network device comprising:
a network interface; and
a bandwidth measurement unit coupled with the network interface, the bandwidth measurement unit configured to:
determine a baseline latency of each of a plurality of routers on a network path between the first network device and a second network device of a network;
determine a subsequent latency of each of the plurality of routers;
identify, from the plurality of routers, a bandwidth limiting router on the network path based, at least in part, on the baseline latency and the subsequent latency of each of the plurality of routers; and
determine an available bandwidth associated with the network path based, at least in part, on the bandwidth limiting router.

21. The first network device of claim 20, wherein the bandwidth measurement unit configured to identify the bandwidth limiting router on the network path comprises the bandwidth measurement unit configured to:
determine a magnitude difference between the subsequent latency and the baseline latency of each of the plurality of routers; and
compare the magnitude differences of the plurality of routers to identify the bandwidth limiting router.

22. The first network device of claim 21, wherein the bandwidth measurement unit configured to compare the magnitude differences of the plurality of routers to identify the bandwidth limiting router comprises the bandwidth measurement unit configured to:
determine that a magnitude difference between the subsequent latency and the baseline latency of a first router from the plurality of routers exceeds a latency difference threshold; and
designate the first router as the bandwidth limiting router of the network path.

23. The first network device of claim 21, wherein the bandwidth measurement unit configured to compare the magnitude differences of the plurality of routers to identify the bandwidth limiting router comprises the bandwidth measurement unit configured to:
determine that a magnitude difference between the subsequent latency and the baseline latency of a first router from the plurality of routers exceeds a latency difference threshold;
determine that the magnitude difference between the subsequent latency and the baseline latency of the first router is the largest magnitude difference associated with the plurality of routers; and
designate the first router as the bandwidth limiting router of the network path.

24. The first network device of claim 20, wherein the bandwidth measurement unit configured to determine the available bandwidth associated with the network path comprises the bandwidth measurement unit configured to:
determine a data rate used for transmitting data packets in the network path when the bandwidth limiting router is identified; and
determine the available bandwidth associated with the network path based, at least in part, on the data rate.

25. The first network device of claim 20, wherein the bandwidth measurement unit configured to determine the baseline latency comprises the bandwidth measurement unit configured to:
transmit a discovery packet from the first network device to each router to cause each router to transmit a response packet to the first network device; and
determine the baseline latency of each router based, at least in part, on the response packet received at the first network device from each router.

26. The first network device of claim 20, wherein the bandwidth measurement unit configured to determine the baseline latency comprises the bandwidth measurement unit configured to, for each of the plurality of routers:
transmit a plurality of discovery packets from the first network device to the router to cause the router to transmit a response packet for each discovery packet transmitted to the router;
determine initial latency measurements for the router based, at least in part, on the response packets received at the first network device from the router; and
determine the baseline latency of the router based, at least in part, on the initial latency measurements.

27. The first network device of claim 26, wherein the bandwidth measurement unit configured to determine the baseline latency comprises the bandwidth measurement unit further configured to select, from the initial latency measurements of each router, a minimum latency measurement as the baseline latency for each router.

28. The first network device of claim 20, wherein the bandwidth measurement unit configured to determine the subsequent latency comprises the bandwidth measurement unit configured to:
transmit a discovery packet from the first network device to each router to cause each router to transmit a response packet to the first network device; and
determine the subsequent latency of each router based, at least in part, on the response packet received at the first network device from each router.

29. The first network device of claim 20, wherein the bandwidth measurement unit configured to determine a subsequent latency comprises the bandwidth measurement unit configured to, for each of the plurality of routers:
transmit a plurality of data packets from the first network device to the router to cause the router to transmit a response packet for each packet transmitted to the router;
determine additional latency measurements for the router based, at least in part, on the response packets received at the first network device from the router; and
determine the subsequent latency of the router based, at least in part, on the additional latency measurements.

30. The first network device of claim 20, further comprising a bandwidth control unit coupled with the bandwidth measurement unit, the bandwidth control unit configured to:
configure the first network device with the available bandwidth; and
control data traffic transmitted via the network path based, at least in part, on the available bandwidth configured at the first network device.

31. A non-transitory machine-readable storage medium having machine executable instructions stored therein, the machine executable instructions comprising instructions to:
determine, at a first network device, a baseline latency of each of a plurality of routers on a network path between the first network device and a second network device of a network;
determine a subsequent latency of each of the plurality of routers;
identify, from the plurality of routers, a bandwidth limiting router on the network path based, at least in part, on the baseline latency and the subsequent latency of each of the plurality of routers; and
determine an available bandwidth associated with the network path based, at least in part, on the bandwidth limiting router.

32. The non-transitory machine-readable storage medium of claim 31, wherein said instructions to identify the bandwidth limiting router on the network path comprise instructions to:
determine a magnitude difference between the subsequent latency and the baseline latency of each of the plurality of routers; and
compare the magnitude differences of the plurality of routers to identify the bandwidth limiting router.

33. The non-transitory machine-readable storage medium of claim 32, wherein said instructions to compare the magnitude differences of the plurality of routers to identify the bandwidth limiting router comprise instructions to:
determine that a magnitude difference between the subsequent latency and the baseline latency of a first router from the plurality of routers exceeds a latency difference threshold; and
designate the first router as the bandwidth limiting router of the network path.

34. The non-transitory machine-readable storage medium of claim 32, wherein said instructions to compare the magnitude differences of the plurality of routers to identify the bandwidth limiting router comprise instructions to:
determine that a magnitude difference between the subsequent latency and the baseline latency of a first router from the plurality of routers exceeds a latency difference threshold;
determine that the magnitude difference between the subsequent latency and the baseline latency of the first router is the largest magnitude difference associated with the plurality of routers; and
designate the first router as the bandwidth limiting router of the network path.

35. The non-transitory machine-readable storage medium of claim 31, wherein said instructions to determine the available bandwidth associated with the network path comprise instructions to:
determine a data rate used for transmitting data packets in the network path when the bandwidth limiting router is identified; and
determine the available bandwidth associated with the network path based, at least in part, on the data rate.

36. The non-transitory machine-readable storage medium of claim 31, wherein said instructions further comprise instructions to:
determine the available bandwidth associated with the network path based, at least in part, on latency measurements associated with the bandwidth limiting router.
